(19) United States
(12) Patent Application Publication
(10) Pub. No.: US 2021/0027139 A1
(43) Pub. Date: Jan. 28, 2021

(54) DEVICE AND METHOD FOR PROCESSING A DIGITAL DATA STREAM

(71) Applicant: Robert Bosch GmbH, Stuttgart (DE)

(72) Inventors: Lukas Lange, Pforzheim (DE); Heike Adel-Vu, Stuttgart (DE); Jannik Stroetgen, Karlsruhe (DE)

(21) Appl. No.: 16/932,043

(22) Filed: Jul. 17, 2020

(30) Foreign Application Priority Data
Jul. 24, 2019 (DE) 102019210994.2

(51) Int. Cl. G06N 3/04; G06F 40/279; G06F 40/166; G06N 3/08

(52) U.S. Cl. CPC G06N 3/0445; G06N 3/08; G06F 40/166; G06F 40/279

(57) ABSTRACT

A computer-implemented method for machine learning and processing of a digital data stream as well as devices for this purpose. A representation of a text is provided independently of a domain, a representation of a structure of the domain being provided, and a model for automatically detecting sensitive text elements being trained as a function of the representations, and data from at least a portion of the data stream, which represent a word, being replaced by data that represent a placeholder for the word, an output of the model being determined as a function of the data, data to be replaced in the data and data that replace the data to be replaced being determined as a function of the output of the model.

### CROSS REFERENCE

The present application claims the benefit under 35 U.S.C. § 119 of German Patent Application No. DE 102019210994.2 filed on Jul. 24, 2019, which is expressly incorporated herein by reference in its entirety.

### BACKGROUND INFORMATION

The present invention is based on a device and a method for processing a digital data stream, in particular using an artificial neural network.

For processing texts for example, recurrent neural networks are used in combination with a conditional random field classifier, CRF. In this instance, each word of a text is represented by a distributional vector, which was previously trained on large quantities of unlabeled text data. For this purpose, concatenated word representations are used for example, which were trained on standard data. An example of this is described in Khin et al. 2018 “A Deep Learning Architecture for De-identification of Patient Notes: Implementation and Evaluation.” https://arxiv.org/abs/1810.01570. For this purpose, an individual word representation is also used for example, which was trained on domain-specific data. An example of this is described in Liu et al. 2017. “De-identification of clinical notes via recurrent neural network and conditional random field.” https://www.sciencedirect.com/science/article/pii/S1532046417301 223.

The results of the models may be improved by rule-based post-processing. General rules, as descrived, e.g., in Liu et al., or training data-specific rules are used for this purpose. An example of the latter is described in Yang and Garibaldi 2014. “Automatic detection of protected health information from clinic narratives.” https://www.sciencedirect.com/science/article/pii/S1532046415001 252.

### SUMMARY

If a set of texts is specified from a collection of documents, for example from a medical domain, sensitive text elements (e.g., personal data) are to be detected in order to make it possible to render the collection of documents anonymous in automated fashion.

In accordance with an example embodiment of the present invention, a computer-implemented method for machine learning provides in this respect that a representation of a text is provided independently of a domain, a representation of a structure of the domain being provided, and a model for automatically detecting sensitive text elements being trained as a function of the representations. A conventional model is thereby extended by domain knowledge. For this purpose, structured domain knowledge is utilized, which goes beyond the domain knowledge that is learnable from the training data. By integrating domain knowledge, a robust model is learned even with few training data.

Advantageously, a rule is provided, which is defined as a function of information about the domain, an output of the model being checked as a function of the rule. Using domain-specific rules, it is possible to check whether the predictions of the model are of sufficient quality. The rules may be specified by a domain expert.

Preferably, a text element is identified as a function of the model and is assigned to a class from a set of classes. A text element is for example a word of a document. This model classifies each word of a present document individually as belonging to a specified set of classes, e.g., sensitive datum or not; or finely granulated name, date, location, etc.

The model preferably comprises a recurrent neural network. This model is particularly well suited for classifying.

In one aspect of the present invention, first word vectors are trained in unsupervised fashion using a first set of domain-independent data, second word vectors being trained in unsupervised fashion using a second set of domain-specific data, the data comprising words, for at least one word a combination of first word vector and second word vector being determined, which represents the word, the model being trained in supervised fashion as a function of the combination. The combination may be implemented by a concatenation of the word vectors and an accordingly dimensioned input of the model, e.g., a corresponding input layer of the artificial neural network. A model for the automatic detection of sensitive text elements is thereby trained, which is extended by domain knowledge.

Preferably, for at least one word, a class is determined for the at least one word as a function of the model, which characterizes a placeholder for the word. The trained model is used in particular for assigning words to placeholders.

Preferably, a check is performed for at least one word as a function of the model to determine whether the word is protected, a class being determined for the placeholder if the at least one word is protected. On this basis, in texts that are to be anonymized automatically, it is possible to classify and replace by placeholders only sensitive words that are to be protected.

Preferably, if a word from a text is protected, a placeholder is determined for the word and a representation of the word is replaced by a placeholder. This represents an automated replacement of the sensitive words in the data stream.

In accordance with an example embodiment of the present invention, a respective method is provided for processing a digital data stream, which comprises digital data, the digital data representing words, provides for data from at least a portion of the data stream, which represent a word, to be replaced by data that represent a placeholder for the word, an output of a model being determined as a function of the data, which is trained in accordance with the previously described method, data to be replaced in the data and data that replace the data to be replaced being determined as a function of the output of the model. The digital data stream may concern a data transmission between two servers, between a server and a client or on an internal bus of a computer. The words would not have to be represented in a form readable by humans. Rather, it is possible to use the representation of the words by the bits in the data stream itself. Sensitive data are thereby automatically detected in the text encoded in the data stream and are replaced by placeholders. Preferably, the representations of the words that are checked are determined from digital data contained in the payload of data packets, which are comprised by the digital data stream.

In accordance with an example embodiment of the present invention, a device for machine learning comprises a processor and a memory for an artificial neural network, which are designed to carry out the method for machine learning.

In accordance with an example embodiment of the present invention, a device for processing a digital data stream comprises a processor and a memory for an artificial neural network, which are designed to carry out the method for processing the digital data stream.

Further advantageous specific embodiments emerge from the following description and the figures.

### BRIEF DESCRIPTION OF THE DRAWINGS

FIG. 1 shows a schematic representation of an example device for machine learning in accordance with an example embodiment of the present invention.

FIG. 2 shows a schematic representation of an example device for processing a digital data stream in accordance with an example embodiment of the present invention.

FIG. 3 shows steps in a method for machine learning in accordance with an example embodiment of the present invention.

FIG. 4 shows steps in a method for processing the digital data stream in accordance with an example embodiment of the present invention.

### DETAILED DESCRIPTION OF EXAMPLE EMBODIMENTS

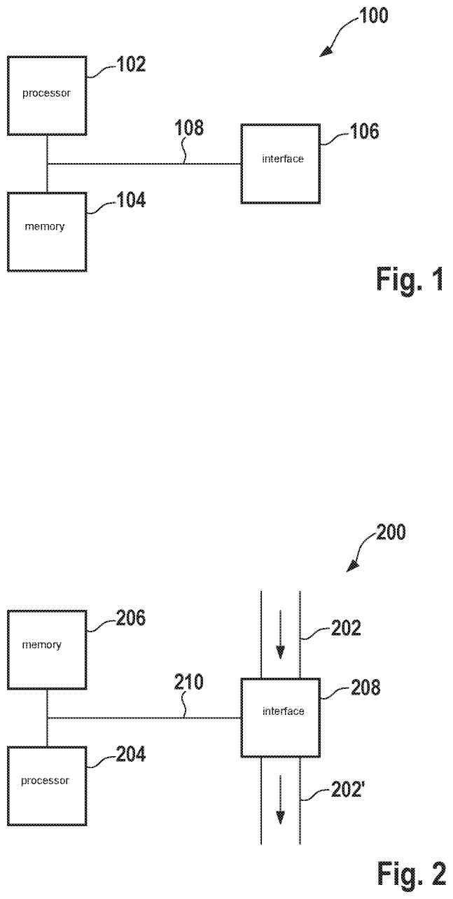

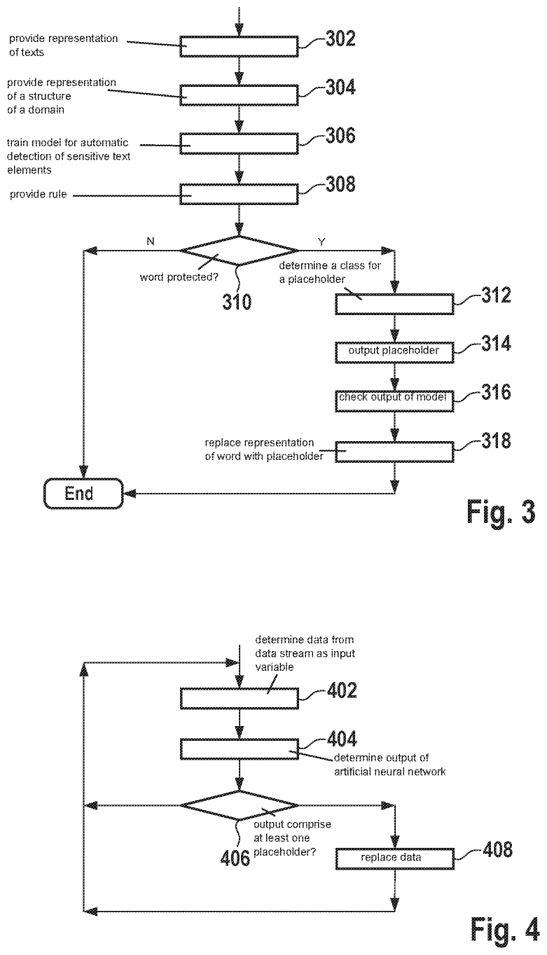

FIG. 1 schematically represents a device 100 for machine learning in accordance with an example embodiment of the present invention. This device 100 comprises a processor 102 and a memory 104 for an artificial neural network. In the example, device 100 comprises an interface 106 for an input and an output of data. Processor 102, memory 104 and interface 106 are connected via at least one data line 108. Device 100 may also be designed as a distributed system in a server infrastructure. These are designed to carry out the method for machine learning that is described below with reference to FIG. 3.

FIG. 2 represents a device 200 for processing a digital data stream 202 in accordance with an example embodiment of the present invention. This device 200 comprises a processor 204 and a memory 206 for the artificial neural network. In the example, device 200 comprises an interface 208 for an input and an output of data. Processor 204, memory 206 and interface 208 are connected via at least one data line 210, in particular a data bus. Processor 204 and memory 206 may be integrated in a microcontroller. Device 200 may also be designed as a distributed system in a server infrastructure. These are designed to carry out the method for processing the digital data stream 202 described below with reference to FIG. 4. A data stream 202′ resulting from the processing of digital data stream 202 as input of interface 208 is shown in FIG. 2 as the output of interface 208.

FIG. 3 represents steps in a method for machine learning in accordance with an example embodiment of the present invention.

In a step 302, a representation of texts is provided independently of a domain. The texts comprise words for example. Individual words are represented by preferably definite domain-nonspecific first word vectors. These are trained as a function of texts that are nonspecific for the domain. The first word vectors are trained in unsupervised fashion using for example a first set of domain-independent data. The data encode words in the example.

In a subsequent step 304, a representation of a structure of the domain is provided. The structure is represented for example by domain-specific second word vectors. These are trained as a function of texts that are specific for the domain. The second word vectors are trained in unsupervised fashion using for example a second set of domain-specific data. The data encode words in the example.

In a subsequent step 306, the model for the automatic detection of sensitive text elements is trained as a function of the representations.

Data for this purpose are produced from documents, for example. The data encode words in the example. For the words, a combination of first word vector and second word vector is determined, which represents the word. The model is trained in supervised fashion as a function of this combination.

By this integration of domain knowledge, a robust model is learned even with few training data.

In the example, the model is an artificial neural network, in particular a recurrent neural network.

These steps may be repeated until a quality criterion for the training is met.

After the training, the following optional steps may be performed for words from any texts.

For example, in a subsequent optional step 308, a rule is provided that is defined as a function of information about the domain. The rule is specified in the example by a domain expert.

For example, in a step 310, a check is performed for a word as a function of the model to determine whether the word is protected. The at least one word is protected for example if it is a word that is classified by the model into a class that is to be automatically anonymized. This is checked as function of the model for example.

If the word is protected, a step 312 is performed. Otherwise, the method is terminated.

In step 312, a class for a placeholder is determined for the word as a function of the model.

Subsequently, a step 314 is performed.

In step 314, a placeholder for the word is determined for an output. The placeholder is for example an anonymization of the word if the word is a sensitive datum such as a name, date or location of a person.

In a subsequent optional step 316, the output of the model is checked as a function of the rule. Using the domain-specific rule, a check is performed in the example to determine whether the predictions of the model are of sufficient quality.

There may be a provision to correct the output as a function of the result of the check or to refrain from using the output.

Subsequently, a step 318 is performed.

In step 318, the representation of the word is replaced by the placeholder. For example, the encoded data that represent the word are replaced by encoded data that represent the placeholder.

Subsequently, the method ends.

FIG. 4 represents steps in a method for processing digital data stream 202 comprising digital data in accordance with an example embodiment of the present invention.

In a step 402, data from the data stream are determined as input variable for an artificial neural network. The data represent at least one word. In the example, the artificial neural network is trained as described previously to find a placeholder for a specific word.

In a subsequent step 404, an output of the artificial neural network is determined as a function of the input data.

In a subsequent step 406, a check is performed to determine whether the output comprises at least one placeholder. If the output comprises at least one placeholder, a step 408 is performed. If the output does not define a placeholder, the method is continued with step 402 for new data, without modifying data stream 202 in the example.

In step 408, as a function of the output of the artificial neural network, data from at least one portion of data stream 202, which represent the at least one word, are replaced by data that represent the at least one placeholder for the word. In the example, the data stream 202′ modified in this manner is output. Subsequently, the method is continued with step 402 for new data.

There may be a provision for determining words and placeholders or their representation in data stream 202 as a function of the output of the artificial neural network.

The words or placeholders would not have to be represented in a form readable by humans. Rather, it is possible to use the representation of the words by the bits in the data stream 202 itself.

What is claimed is:

1. A computer-implemented method for machine learning, the method comprising the following steps:
providing a first representation of a text independently of a domain;
providing a second representation of a structure of the domain; and
training a model for automatically detecting sensitive text elements as a function of the first and second representations, wherein first word vectors are trained in unsupervised fashion using a first set of domain-independent data, second word vectors are trained in unsupervised fashion using a second set of domain-specific data, the domain-independent data and the domain-specific data including words, for at least one word of the words, a combination of a first word vector of the first word vectors and a second word vector of the second word vectors is determined, which represents the word, the model being trained in supervised fashion as a function of the combination.

2. The method as recited in claim 1, further comprising the following step:
providing a rule which is defined as a function of information about the domain, an output of the model being checked as a function of the rule.

3. The method as recited in claim 1, wherein a text element is identified as a function of the model and is assigned to a class from a set of classes.

4. The method as recited in claim 1, wherein the model includes a recurrent neural network.

5. The method as recited in claim 1, wherein, for at least one word of the words, a class is determined for the at least one word as a function of the model, which characterizes a placeholder for the word.

6. The method as recited in claim 5, wherein a check is performed for at least one word of the words as a function of the model to determine whether the word is protected, a class being determined for the placeholder when the at least one word is protected.

7. The method as recited in claim 6, wherein, if a word from a text is protected, a placeholder is determined for the word and a representation of the word is replaced by the placeholder.

8. A method for processing a digital data stream, which comprises digital data, the digital data representing words, the method comprising the following steps:
replacing data from at least a portion of the data stream, which represent a word, by data that represent a placeholder for the word, the data to be replaced and the data that replaces being determined as a function of an output of a model;
the output of the model being determined as a function of the data, the model being trained by:
providing a first representation of a text independently of a domain;
providing a second representation of a structure of the domain; and
training a model for automatically detecting sensitive text elements as a function of the first and second representations, wherein first word vectors are trained in unsupervised fashion using a first set of domain-independent data, second word vectors are trained in unsupervised fashion using a second set of domain-specific data, the domain-independent data and the domain-specific data including words, for at least one word of the words, a combination of a first word vector of the first word vectors and a second word vector of the second word vectors is determined, which represents the word, the model being trained in supervised fashion as a function of the combination.

9. A device for machine learning, the device comprising:
a processor and a memory for an artificial neural network;
wherein the device is configured to:
provide a first representation of a text independently of a domain;
provide a second representation of a structure of the domain; and
train a model for automatically detecting sensitive text elements as a function of the first and second representations, wherein first word vectors are trained in unsupervised fashion using a first set of domain-independent data, second word vectors are trained in unsupervised fashion using a second set of domain-specific data, the domain-independent data and the domain-specific data including words, for at least one word of the words, a combination of a first word vector of the first word vectors and a second word vector of the second word vectors is determined, which represents the word, the model being trained in supervised fashion as a function of the combination.

10. A device for processing a digital data stream, which comprises digital data, the digital data representing words, the device comprising:
a processor and a memory for an artificial neural network;
wherein the device is configured to:
replace data from at least a portion of the data stream, which represent a word, by data that represent a placeholder for the word, the data to be replaced and the data that replaces being determined as a function of an output of a model;
the output of the model being determined as a function of the data, the model being trained by:
providing a first representation of a text independently of a domain;
providing a second representation of a structure of the domain; and
training the model for automatically detecting sensitive text elements as a function of the first and second representations, wherein first word vectors are trained in unsupervised fashion using a first set of domain-independent data, second word vectors are trained in unsupervised fashion using a second set of domain-specific data, the domain-independent data and the domain-specific data including words, for at least one word of the words, a combination of a first word vector of the first word vectors and a second word vector of the second word vectors is determined, which represents the word, the model being trained in supervised fashion as a function of the combination.

11. A non-transitory machine-readable medium on which is stored a computer program for machine learning, the computer program, when executed by a computer, causing the computer to perform the following steps:
providing a first representation of a text independently of a domain;
providing a second representation of a structure of the domain; and
training a model for automatically detecting sensitive text elements as a function of the first and second representations, wherein first word vectors are trained in unsupervised fashion using a first set of domain-independent data, second word vectors are trained in unsupervised fashion using a second set of domain-specific data, the domain-independent data and the domain-specific data including words, for at least one word of the words, a combination of a first word vector of the first word vectors and a second word vector of the second word vectors is determined, which represents the word, the model being trained in supervised fashion as a function of the combination.

12. A non-transitory machine-readable medium on which is stored a computer program for processing a digital data stream, which comprises digital data, the digital data representing words, the computer program, when executed by a computer, causing the computer to perform the following steps:
replacing data from at least a portion of the data stream, which represent a word, by data that represent a placeholder for the word, the data to be replaced and the data that replaces being determined as a function of an output of a model;
the output of the model being determined as a function of the data, the model being trained by.
providing a first representation of a text independently of a domain;
providing a second representation of a structure of the domain; and
training the model for automatically detecting sensitive text elements as a function of the first and second representations, wherein first word vectors are trained in unsupervised fashion using a first set of domain-independent data, second word vectors are trained in unsupervised fashion using a second set of domain-specific data, the domain-independent data and the domain-specific data including words, for at least one word of the words, a combination of a first word vector of the first word vectors and a second word vector of the second word vectors is determined, which represents the word, the model being trained in supervised fashion as a function of the combination.
